(19) United States
(12) Patent Application Publication
(10) Pub. No.: US 2006/0174025 A1
(43) Pub. Date: Aug. 3, 2006

(54) System and method for streaming content utilizing client upstream communication bandwidth capacity over a network

(75) Inventors: John Hayden LaRue JR., Dallas, TX (US); Jason Gardner, Plano, TX (US); Brian Kleinfall, Richardson, TX (US); Michael Cruz, Grand Prairie, TX (US)

Correspondence Address: PATTON BOGGS, L.L.P., 2001 ROSS AVENUE, SUITE 3000, DALLAS, TX, 75201, US

(73) Assignee: John H. LaRue, Jr., Dallas, TX (US)

(21) Appl. No.: 11/047,878

(22) Filed: Feb. 1, 2005

(51) Int. Cl. G06F 15/16

(52) U.S. Cl. 709/231

(57) ABSTRACT

A system and method for distributing content over a network including a server and a first client device in communication with the server over a first data communication link and first control communication link over the network. A second client device may be in communication with the server over a second control communication link over the network and the first client device over a second data communication link over the network.

### BACKGROUND OF THE INVENTION

1. Technical Field of the Invention

The principles of the present invention provide for distributing content over a network, and more particularly, but not by way of limitation, to a system and method for distributing content to client devices configured in a tree structure from a server utilizing excess capacity of upstream communication bandwidth allocated to the client devices.

2. Description of Related Art

Network servers that serve large numbers of client devices over a network generally require high bandwidth communication lines for distributing content, such as streaming music, to the client devices. The cost to have the high bandwidth communication lines can be very expensive, often six to ten dollars per client per month. This means that a network server that serves 100,000 or more client devices in a given month may have access fees to service providers in excess of a million dollars. To pay for the high cost of operating a network server with high bandwidth communication lines, operators are forced to provide large amounts of advertising to the client devices, which is difficult for the operator to obtain and generally unwanted by users operating the client devices.

Each client device is generally allocated a certain amount of bandwidth for communications. The communications allocated include both upstream and downstream communications. For example, network communication providers of digital subscriber lines (DSL) typically provide 1.5 megabits per second (Mbaud) that are split between downstream and upstream communications for the client devices. The upstream communication bandwidth is generally lower (e.g., 128 Kilobaud) than the downstream communication bandwidth (e.g., 768 Kilobaud) because, in general, most subscribers download more often than upload. Because most subscribers do not utilize the full capacity of the upstream communication bandwidth, there is excess capacity of upstream communication bandwidth that is unutilized.

### SUMMARY OF THE INVENTION

To overcome the problem of the high cost of operating network servers or servers with large numbers of client devices accessing and downloading content, the principles of the present invention provide for client devices requesting access to content from a server to be configured in a tree structure. Upstream communication bandwidth capacity of client devices located on the tree structure may be reallocated so that the content being distributed from the server may be communicated via the tree structure to client devices utilizing a lower bandwidth communication line from the server. The use of the lower bandwidth communication line results in the operator of the server saving money. The content being distributed through the tree structure of client devices may be encrypted to prevent client devices along the tree from altering the content prior to retransmission. The reallocation of communication bandwidth capacity may be only a portion of the upstream communication (e.g., 48 Kbaud of 128 Kbaud) for each client device so that the client devices is substantially unaffected in operation.

In one embodiment, the principles of the present invention provide for a system and method including a server and a first client device in communication with the server over a first data communication link and first control communication link. A second client device may be in communication with the server over a second control communication link and the first client device over a second data communication link.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an illustration of an exemplary tree structure of a server and clients having upstream bandwidth capacity reallocated for downstream communication;

FIG. 2 is an illustration of a more detailed exemplary tree structure of a server and client devices;

FIG. 3 is an illustration of a flow diagram of an exemplary process for configuring client devices in a tree structure;

FIG. 4 is an illustration of a flow diagram of a more detailed process for configuring client devices in a tree structure;

FIG. 5 is an illustration of a flow diagram of an exemplary process for content being communicated along a tree structure of client devices; and

FIG. 6 is an illustration of a flow diagram of an exemplary process for reconfiguring a tree structure if a node-client is disconnected to continue serving clients without interruption of content being served to the clients.

### DETAILED DESCRIPTION OF THE EXEMPLARY EMBODIMENTS

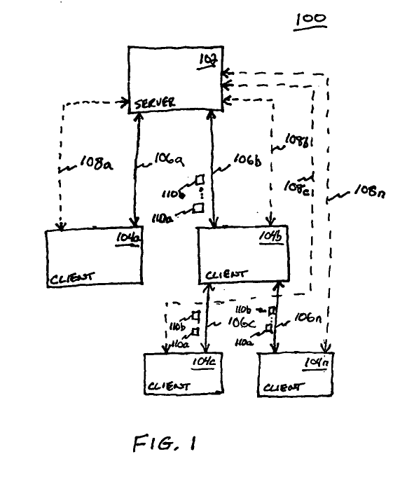

FIG. 1 illustrates an exemplary tree structure 100 of a server and clients having upstream communication bandwidth capacity reallocated for downstream communication. The tree structure 100 or network of client devices is shown, where a server 102 is used to host client devices 104a-104n (collectively 104). The server 102 may operate as a base location that the client devices 104 request a connection to download or upload content as understood in the art. To reduce the communication bandwidth needed to distribute content from the server 102, client devices 104 that request a connection may be configured into a tree structure 100 so that the server 102 may serve fewer client devices 104 directly. Although the server 102 may serve fewer client devices 104 directly, the content communicated to the client devices 104 may be distributed to a large number of client devices 104 via client devices 104 configured as servers.

A client device 104 is a device that requests a connection with a server device and receives content therefrom. The client devices 104 may be computing devices, such as personal computers (PCs), personal digital assistants (PDAs), mobile phones, and other wired and wireless devices. The content may be streaming music and/or video. Alternatively, the content may be a public announcement, including emergency reports, Amber Alerts, weather reports, and terrorist activities. Still yet, the content may be information as distributed for business communications, such as police reports. In addition, the content may be data used to display graphics on a client application, including information relating to sporting events and the stock market.

More specifically, the client devices 104 may be configured directly in communication with the server 102 (e.g., 104a and 104b) or indirectly in communication with the server 102 (e.g., 104c and 104n). The client devices 104 that directly communicate with the server 102 may or may not have other client devices 104 in communication therewith in the tree structure 100. Client devices 104 that do not have other client devices positioned (visually) below are considered leaf-client devices (e.g., 104a, 104c, and 104n) and client devices 104 that have other client devices positioned below are considered node-client devices (e.g., 104b). In addition, client devices positioned higher in the tree structure 100 are considered parent client devices (e.g., 104b) to children client devices (e.g., 104c) positioned below the parent client devices. Node-client devices may be considered server or repeater client devices as these client devices are utilized to communicate information received from the server 102 to children client devices.

Continuing with FIG. 1, two types of communication links are shown, including (i) data communication links 106a-106n (collectively 106) shown as solid lines and (ii) control communication links 108a-108n (collectively 108) represented as dashed lines. It should be understood that the data and control communication links 106 and 108 may be configured over a network. The network over which the communication links 106 and 108 may be configured may include the Internet, Intranet, Extranet, wide area network (WAN), local area network (LAN), wireless, satellite, or any other communications network. In one embodiment, the communications network is a digital communications network. However, alternative communications networks, such as analog and optical networks, may be utilized in accordance with the principles of the present invention.

The data communications link between the server 102 and the clients 104a and 104b may be a conventional communication link as understood in the art. However, the data communication links 106c and 106n between the node-client device 104b and leaf-client devices 104c and 104n may be a conventional data communication link and utilize communication bandwidth capacity allocated to the node-client device 104b for upstream communications. In one embodiment, the data communication link is a TCP/IP communication protocol. Other stateful protocols may alternatively be used, including JXTA™ from Sun Microsystems, Inc., that provides for peer-to-peer communications over various platforms and through firewalls. By reallocating the upstream communication bandwidth capacity for downstream communications to client devices lower in the tree structure 100 (e.g., to leaf client 104c), the node-client device 104b is substantially unaffected for downloading functionality.

The control communication links 108 are configured by the server 102 in response to a request to establish a connection between the client devices 104 and the server 102. However, the control communication links 108 may be low bandwidth communication links and be utilized for determining whether or not a client device disconnects or becomes disconnected from the tree structure 100. By monitoring the control communication links 108, the server 102 may determine if a node-client device that is serving other client devices disconnects. If the node-client device disconnects from the server 102, then the other client devices 104 being served by the node-client device may be reconfigured to other client devices 104 having available upstream communication bandwidth capacity to serve the now unlinked client devices. The control communication links 108 may be stateful communication links that include handshaking as understood in the art so that an active determination may be made if a disconnection between a client device 104 and server 102 occurs. In one embodiment, the control communication links 108 operate at 2 KHz and utilize the transmission control protocol (TCP/IP). It should be understood that other control protocols may be utilized to provide the control communication links 108.

In operation, a client device 104b may initially be configured as a leaf-client device. A leaf-client device may be allocated with a high speed downstream communication link and a lower speed upstream link. In one embodiment, the upstream communication link has a bandwidth of 128 Kilobaud (Kbaud). As additional client devices request content from the server 102, the requesting client devices may be configured to have a communication link between a leaf- or node-client device having excess capacity of upstream communication bandwidth. For example, the 128 Kbaud upstream communication bandwidth link of the client device 104b may be partitioned to have two 24 Kbaud communication bandwidth links to enable two client devices to be in communication therewith (e.g., 104c and 104n). As understood in the art, a 24 Kbaud communication link may be adequate for communication of relatively low speed content, such as music or other data that mayor may not require real time communications. It should be understood that higher or lower communication links may be reallocated from the available upstream communication bandwidth capacity of client devices 104 as desired and/or available.

As further shown in FIG. 1, content may be communicated from the server 102 to client devices via data packets 110a-110b (collectively 110). The content received by the client device 104b may be stored in a buffer and recommunicated to other client devices 104c and 104n in data packets 110. If encrypted, the content may be buffered as encrypted and similarly recommunicated.

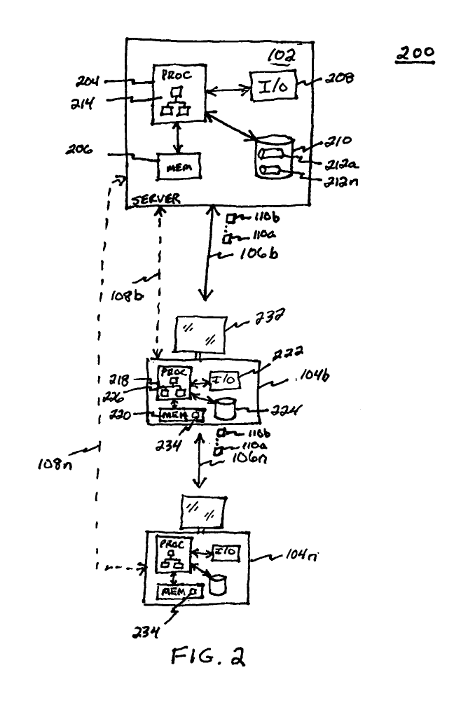

FIG. 2 illustrates a more detailed exemplary tree structure 200 including the server 102 and client devices 104b and 104n (FIG. 1). The server 102 includes a processor 204 in communication with a memory 206, input/output (I/O) device 208, and storage unit 210. The storage unit 210 may include one or more repositories of information 212a-212n (collectively 212). In one embodiment, the repositories 212 are databases. The processor 204 may execute software 214 utilized to manage data and/or content stored in the repositories 212 and utilized to configure and manage client devices configured in a tree structure. To manage the tree structure, a list or other type of repository may be stored in the repositories 212 as shown in TABLE I.

TABLE I

| | | Available | | Serving | |
|---|---|---|---|---|---|
| | | Upstream Comm. | Server IP | Client IP | Client IP |
| IP Address | Unique ID | BW Capacity | Address | Address | Address |
| 1.160.10.240 | 102 | — | — | 1.180.14.102 | 1.180.14.103 |
| 1.180.14.102 | 104a | 128 | 1.160.10.240 | — | — |
| 1.180.14.103 | 104b | 80 | 1.160.10.240 | 1.244.19.124 | 1.244.19.125 |
| 1.244.19.124 | 104c | 128 | 1.180.14.103 | — | — |
| 1.244.19.125 | 104n | 128 | 1.180.14.103 | — | — |

As shown in TABLE I, which makes reference to devices in the tree structure of FIG. 1, the device having unique ID 102 operates as the server 102 serving client devices having unique IDs 104a and 104b. Client device 104a having unique ID 104a and IP address 1.180.14.102 has available upstream communication bandwidth capacity, but is not serving any client devices. Client device 104b having unique ID 104b has available upstream communication bandwidth capacity that is reallocated to serve client devices having unique IDs 104c and 104n. Both client devices having unique IDs 104c and 104n have available upstream communication bandwidth capacity, but do not serve any clients. Other relevant information for managing the tree structure may be stored in the list.

Continuing with FIG. 2, client devices 104b and 104n maybe configured in a tree structure to receive and distribute content from the server 102. The client devices 104b and 104n may include similar or the same components as the server 102, including a processor 218 that communicates with memory 220, I/O unit 222, and storage unit 224. The processor 218 may execute software 226 that causes the I/O unit 222 to communicate data along a control communications link 108b and data communications link 106b. In addition, the software 226 may be utilized to operate a client software application to display content received from the server 102 on a monitor 232 and/or play through a speaker (not shown). For example, the software 226 may be an application, such as a music player, programmed in the JAVA programming language to be platform independent and content receiver from a server, such as streaming music. In addition, the software 220 may operate to retransmit content to client devices lower in the tree, such as client device 216n. The software 226 may operate to buffer the content in a buffer 234 operating in the memory and rebroadcast the buffered content via the data communications link 106n.

As shown, each of the client devices 104b and 104n maintains a control communications link 108b and 108n, respectively, so that the software 214 being executed by the processor 204 on the server 102 may monitor and determine when a client device 216 disconnects from the server 102 and tree structure. For example, in the event that the client device 104b operating as a node-client device and serving content via client device 104n is disconnected, the software 214 may reconfigure the client device 104n to (i) another client device having available upstream bandwidth capacity or (ii) directly to the server 102. A stateful protocol for the control communication links 108b may be utilized so that the server 102 may determine when the client device 104b becomes disconnected when a response to a status inquiry is not received in response thereto.

In one embodiment, the server 102 operates to stream content via data packets 110, such as music and/or video. As each of the client devices 216 request distribution of the content, the content is streamed over the communication links 106b and 106n. Between the server 102 and the client device 104b, the content is communicated over the downlink communication link 106b and between the client device 104b and 104n, the content is communicated over the upstream communication link 104n from the point-of-view of the client device 104b, which is the downstream communication link from the point-of-view of the client device 104n. The software 226 being executed by the processor 218 of the node-client device 104b may buffer the content in the buffer 234 of the memory 220 in a compressed and/or encrypted state. For example, as the content is communicated to the client device 104b, sixty seconds of the content may be buffered in the memory 220 so that if the control communication link 106b is severed, the server 102 has enough time to reconfigure the client device 104n to another node-client device so that there is no interruption of service of the content to the client device 104n so a stream of content, which may include a time indicator, can be synchronized by moving a real-time pointer in the buffer 334 to point to the location of the content currently being played or streamed. By maintaining a sufficient latency (e.g., 30 seconds) utilizing the buffer 234, disruption of service is a condition that is substantially eliminated.

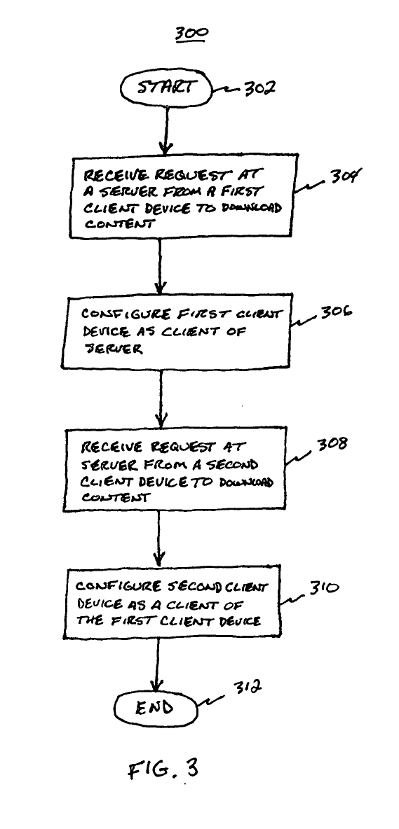

FIG. 3 illustrates a flow diagram of an exemplary process for configuring client devices in a tree structure. The configuration process starts at step 302. At step 304, a request is received at a server from a first client device to download content. At step 306, the first client device is configured as a client of the server. A request may be received at the server from a second client device to download content at step 308. The content may be the same or different content requested by the first client device. At step 310, the second client device may be configured as a client of the first client device, thereby making the first client device a server of the second client device. The process ends at step 312.

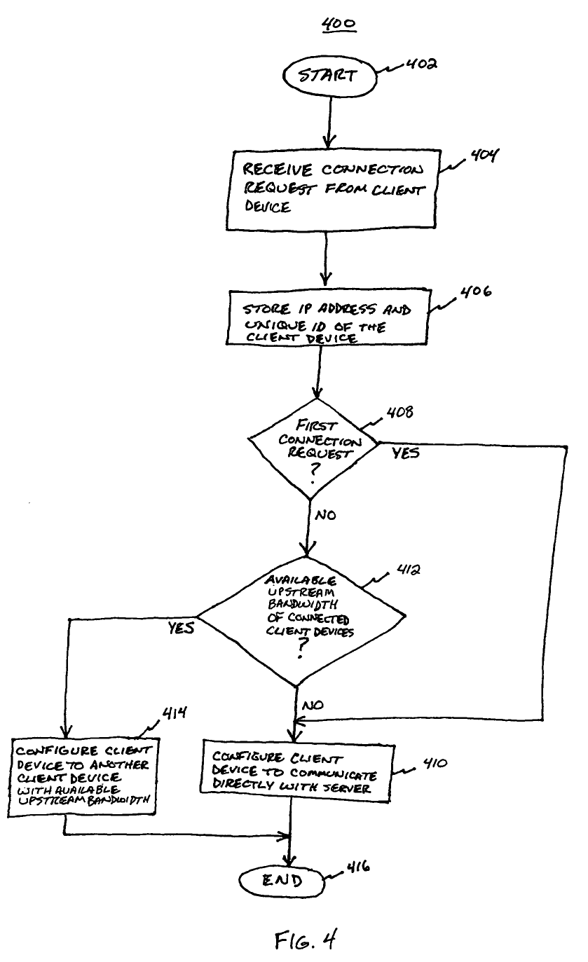

FIG. 4 illustrates a flow diagram of a more detailed process for configuring client devices in a tree structure. The configuration process starts at step 402. At step 404, a connection request by a client device to the server is received from a client device. An Internet protocol (IP) address and unique identifier of the client device may be stored. A determination is made if the connection request is the first connection request at step 408. If the connection request is the first connection request, then the client device is configured to communicate directly with the server at step 410. However, if the connection request is not the first connection request to the server, then a determination is made as to whether there is available upstream communication bandwidth capacity of client devices that are currently connected or in communication with the server at step 412. The client devices having available upstream communication bandwidth capacity may be located anywhere on a tree structure of client devices that receive communications from the server. If there is no available upstream communication bandwidth capacity of client devices in the tree structure, then the client device is configured to communicate directly with the server. However, if it is determined that there is an available client device having available upstream communication bandwidth capacity, then the client device is configured to another client device with the available upstream communication bandwidth capacity at step 414. The process ends at step 416.

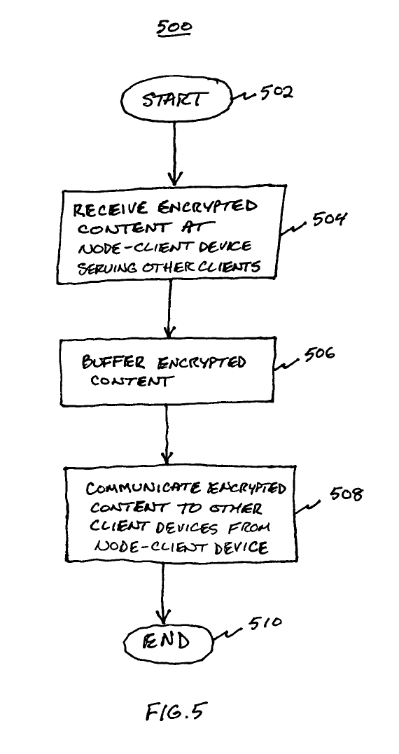

FIG. 5 illustrates a flow diagram of an exemplary process for content being distributed along the tree structure of client devices. The content distribution process starts at step 502. At step 504, encrypted content is received at the node-client device serving other client(s) operating a client application. At step 506, the encrypted content may be buffered by the client application in addition to decrypting and playing and/or displaying the content. The buffering may be in a portion of RAM of the node-client device. By buffering the encrypted content, a latency may be added to provide enough time for a node-client device to be replaced if the communication link between the node-client device and the server becomes severed. At step 508, the encrypted content may be communicated to other client devices from the node-client device utilizing upstream communication bandwidth capacity of the node-client device. In one embodiment, decrypted content is incapable of being retransmitted by a client application operating on a node-client device. The process ends at step 510.

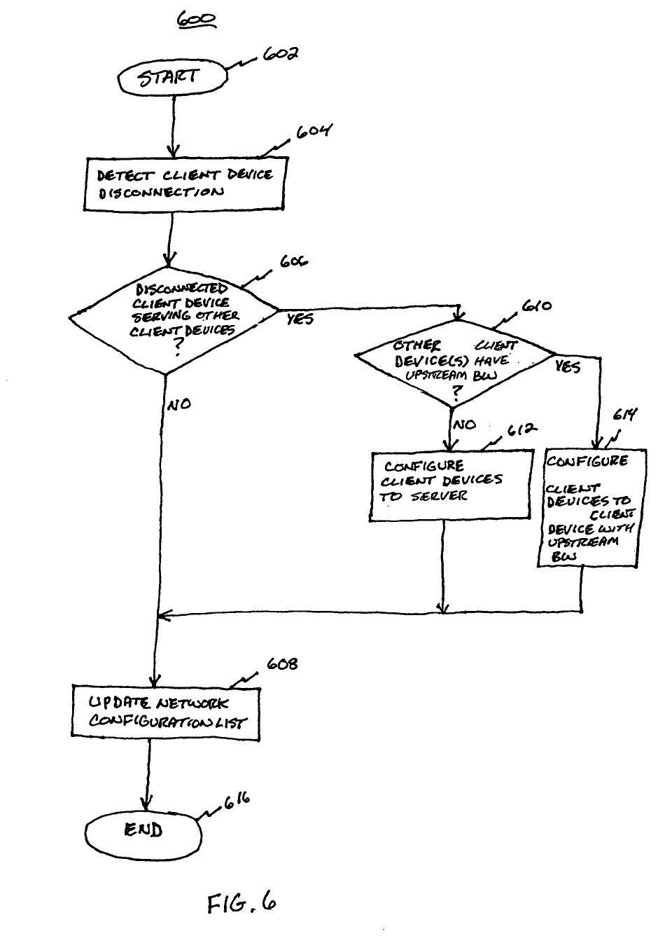

FIG. 6 illustrates a flow diagram of an exemplary process for reconfiguring a tree if a node client is disconnected to continue serving clients without interruption of content. A disconnection may occur if a client device is turned off, a communication cable is disconnected, a client application is turned off, or other disconnecting action is taken. The process starts at step 602. At step 604, a client device disconnection is detected. At step 606, a determination is made as to whether the disconnected client device serves other client devices. If not, a network configuration list is updated at step 608. However, if the disconnected client device is serving other client devices, a determination is made as to whether other client device(s) have available upstream communication bandwidth capacity. If not, then the other client devices being served from the disconnected device are configured to have a communication link directly to the server at step 612. However, if other client device(s) have available upstream communication bandwidth capacity, the client devices being served by the disconnected client device are configured to have a communication link to one or more client devices having available upstream communication bandwidth capacity. The network configuration list is updated at step 608 to show the new configuration of the client devices in a tree structure. The process ends at step 616.

The innovative concepts described in the present application can be modified and varied over a wide rage of applications. Accordingly, the scope of patented subject matter should not be limited to any of the specific exemplary teachings discussed, but is instead defined by the following claims.

We claim:

1. A system for distributing content, comprising:
a server operable to distribute content via a network;
a first client device in communication with said server over a first data communication link and first control communication link over the network; and
a second client device in communication with said server over a second control communication link over the network and said first client device over a second data communication link over the network.

2. The system according to claim 1, wherein the first data communication link has predetermined upstream and downstream bandwidth capacity.

3. The system according to claim 2, wherein the second data communication link is configured by utilizing a portion of the upstream communication bandwidth capacity from said first client.

4. The system according to claim 1, wherein the control communication link utilizes a stateful protocol.

5. The system according to claim 4, wherein the stateful protocol is transmission control protocol (TCP).

6. The system according to claim 1, further comprising software executed by said server and configured to maintain a list of client devices in communication with said server and available upstream communication bandwidth capacity of the associated communication links.

7. The system according to claim 6, wherein said software further monitors whether said first client device loses connection from said server via the first control link and, if the connection is lost, connects said second client device to another client to receive content being communicated from said server.

8. The system according to claim 1, further comprising software executed by said server operable to encrypt content for communication to said first client device.

9. The system according to claim 8, further comprising software executed by said first client device operable to receive and communicate the encrypted content to said second client device.

10. The system according to claim 9, wherein said software is further operable to buffer the encrypted content prior to communication to said second client device.

11. The system according to claim 1, wherein said first and second client devices are personal computers.

12. The system according to claim 1, wherein the network is the Internet.

13. The system according to claim 1, wherein the content is music.

14. The system according to claim 1, wherein the content includes information related to a public announcement.

15. The system according to claim 14, wherein the content includes information related to an emergency.

16. The system according to claim 15, wherein the content includes information related to terrorist activities.

17. A method for configuring a network, said method comprising:
configuring a first client device as a client of a server in response to a request to the server by the first client device to download content from the server; and
configuring a second client device as a client of the first client device in response to a request to the server by the second client device to download content from the server.

18. The method according to claim 17, wherein said configuring of the second client device as a client of the first client device includes utilizing a portion of upstream communication bandwidth capacity available to the first client device in establishing a communication link between the first and second client devices.

19. The method according to claim 17, further comprising establishing a control communication link between the server and second client device.

20. The method according to claim 19, wherein said establishing of the control communication link includes establishing a stateful communication link.

21. The method according to claim 17, further comprising communicating the content requested by the second client device from the server via the first client device.

22. The method according to claim 21, further comprising encrypting the content at the server.

23. The method according to claim 22, further comprising decrypting the content at the second client device.

24. The method according to claim 21, further comprising buffering the encrypted content at the first client device.

25. The method according to claim 24, further comprising monitoring whether the first client device loses connection from the server and, if the connection is lost, connecting the second client device to another client to receive the content being communicated from the server.

26. The method according to claim 17, further comprising communicating the content requested by the second client device from the first client device to the second client device utilizing upstream communication bandwidth capacity allocated to the first client device.

27. The method according to claim 17, further comprising communicating the content from the server, wherein the content includes music.

28. The method according to claim 17, further comprising communicating the content from the server, wherein the content includes a public announcement.

29. The method according to claim 28, further comprising communicating the content from the server, wherein the content includes information related to terrorist activities.

30. A system for configuring a network, said system comprising:
means for configuring a first client device as a client of a server in response to a request to the server by the first client device to download content from the server; and
means for configuring a second client device as a client of the first client device in response to a request to the server by the second client device to download content from the server.

31. The system according to claim 30, further comprising means for establishing a control communication link between the server and second client device.
